(19) United States
(12) Patent Application Publication
(10) Pub. No.: US 2015/0100580 A1
(43) Pub. Date: Apr. 9, 2015

(54) METHOD FOR MANAGING COMMUNICATION RECORDS AND ELECTRONIC DEVICE THEREOF

(71) Applicant: Samsung Electronics Co., Ltd., Gyeonggi-do (KR)

(72) Inventors: Akhila MATHUR, Haryana (IN); Ayushi GUPTA, Haryana (IN); Shashank SHEKHAR, Kankarbagh-Patna (IN); Sanket MAGARKAR, Maharashtra (IN); Mahelaqua, New Delhi (IN); Kalika ARORA, New Delhi (IN); Anupam DUTTA, New Delhi (IN); Priyanka GOEL, Roorkee(Uttarakhand) (IN)

(73) Assignee: Samsung Electronics Co., Ltd.

(21) Appl. No.: 14/507,392

(22) Filed: Oct. 6, 2014

(30) Foreign Application Priority Data
Oct. 4, 2013 (IN) 2965/DEL/2013

(51) Int. Cl. G06F 17/30

(52) U.S. Cl. CPC G06F 17/30705; G06F 17/30722; G06F 17/30696
USPC 707/737

(57) ABSTRACT

A method for aggregating communication records is provided and includes obtaining a communication report corresponding to each of one or more communication events. The communication events indicate an occurrence of communication between a first user and a second user using a communication mode from among a plurality of communication modes. Each of the communication records are classified into one or more communication categories based on one or more classification parameters. The communication records are aggregated based on the classifying weightage assigned to one or more contextual parameters corresponding to each of the plurality of communication records. The contextual parameters indicate relevance of the corresponding communication record and the communication mode corresponding to the communication record.

### PRIORITY

This application claims priority under 35 U.S.C. §119(a) to Indian Patent Application Serial No. 2965/DEL/2013 filed in the Indian Intellectual Property Office on Oct. 4, 2013, the entire disclosure of which is incorporated herein by reference.

### BACKGROUND OF THE INVENTION

1. Field of the Invention

The present disclosure relates generally to a method for managing communication records and an electronic device thereof.

2. Description of the Related Art

Communication devices, such as mobile phones, tablets, and laptops have seemingly become a ubiquitous part of today's lifestyle. The communication devices provide users with a variety of communications services and computer networking capabilities. These communications services allow data to be exchanged between the users. The data exchanged by the communication device can be divided into various categories based on the mode of communication, such as audio calls, text messages, and emails, used for the data exchange. Each category of data exchange may be further segregated into various sub-categories of data based on the characteristics of the data. For example, the calls may be further categorized as received calls, outgoing calls, or missed calls. Records of such data exchange are typically stored in the communication device along with communication details, such as the time of initiation and/or completion of the data exchange, duration of data exchange, and contact details of a user with whom the data exchange took place. Generally, the records and the communication details are segregated and stored based on the mode of communication used for the data exchange.

Usually manufacturers of communication devices assign a pre-defined space in the storage media of the communication device to store the records corresponding to the data exchanged through different communication modes. For instance, records corresponding to audio calls may be saved in a call log. The call records may be further categorized into sub-categories, such as received call, outgoing call, and missed call. Similarly, the data exchanged by the communication devices in the form of text messages may be saved as a list of messages or message records which can be accessed when the user accesses a messaging application installed on the communication device. The message records may be further segregated into various subcategories for the purpose of storage. For example, the received messages may be saved in an inbox and the sent messages may be saved as sent items. As would also be appreciated by a person skilled in the art, different modes of communication can be implemented by a variety of communication clients/applications installed on the communication device. The communication records in turn are only accessible through the respective communication clients. To this extent, the communication records pertaining to communication between users is segregated.

Storing the records corresponding to the communication between the users, at different storage locations may however require the user to switch between the different communication clients and go through the records corresponding to the communication mode. For instance, if a user is communicating with another user using text messages and needs to check an email sent by the other user, the user will have to close the messaging window, open an email client, search the email, then close the email client, and reopen the messaging window to resume the communication. Such a process of switching between the various clients not only affects the user's experience but also consumes resources, such as battery of the communication device and may also lower down the processing speed of the communication device due to the constant switching.

Further, such a segregated storing of records may also lead to user dissatisfaction and delay in communication in cases where the communication mode that the user wants to use is different from the communication mode in which the user received data from the other user. Furthermore, such communication records are silent on the content of the data exchange, for instance, in text messages and emails, due to which the user either has to go through all the communication records, in all the communication modes, to find out the records corresponding to a particular content of conversation or memorize the date and time of such conversations.

One of the conventional techniques for organizing such communication records include creating logs of text message and audio calls made by the user of the communication device. However, such logs are limited to display of time and date of the data exchange along with the contact number of the other user with whom the data was exchanged. In order to access the text message or send a new message the user still needs to switch to the messaging client, thus increasing the time required for data exchange and consumption of the resources.

### SUMMARY OF THE INVENTION

The present disclosure has been made to address at least the problems and/or disadvantages described above and to provide at least the advantages described below.

Accordingly, an aspect of the present disclosure provides systems and methods for communication records management in communication devices. The methods can be implemented in various computing devices, such as mobile phones, hand-held devices, tablets, net books, lap tops or other portable computers, personal digital assistants (PDAs), and notebooks.

In accordance with an aspect of the present disclosure, a method in an electronic device is provided. The method includes obtaining a communication record corresponding to each of one or more communication events, wherein the communication event indicates an occurrence of communication between a first user and a second user using a communication mode from among a plurality of communication modes; classifying each of a plurality of communication records corresponding to the one or more communication events, into one or more communication categories based on one or more classification parameters; and aggregating the plurality of communication records based on the classifying and weightage assigned to one or more contextual parameters corresponding to each of the plurality of communication records, wherein the contextual parameters indicate relevance of the communication record and the corresponding communication mode corresponding to the communication record.

In accordance with an aspect of the present disclosure, an electronic device is provided. The electronic device includes a processor; a data accumulator module coupled to the processor to obtain a communication report corresponding to each of one or more communication events, wherein the communication event indicates an occurrence of communication between a first user and a second user using a communication mode from among a plurality of communication modes; an analysis module coupled to the processor to classify each of a plurality of communication records corresponding to one or more communication events, into one or more communication categories based on one or more classification parameters; and a context builder module coupled to the processor configured to aggregate the plurality of communication records based on the classifying and weightage assigned to one or more contextual parameters corresponding to each of the plurality of communication records, wherein the contextual parameters indicate relevance of the communication record and the communication mode corresponding to the communication record.

In accordance with an aspect of the present disclosure, an electronic device is provided. The electronic device includes a processor; a data accumulator module coupled to the processor to obtain a communication report corresponding to each of one or more communication events, wherein the communication event indicates an occurrence of communication between a first user and a second user using a communication mode from among a plurality of communication modes; an analysis module coupled to the processor to classify each of a plurality of communication records corresponding to one or more communication events, into one or more communication categories based on one or more classification parameters; and a context builder module coupled to the processor configured to determine ranking for each of the plurality of communication modes associated with each of the communication records corresponding to the second user based on weightages assigned to one or more contextual parameters, wherein the contextual parameters indicate relevance of the communication record and the communication mode corresponding to the communication record; aggregate the plurality of communication records in a single presentation view based on the classifying, wherein the communication modes for each of a communication type are arranged in an order of their probable usage by the first user for interacting with the second user based on the ranking for providing an instant communication initiation option to the first user for initiating communication with the second user directly through the presentation view.

### BRIEF DESCRIPTION OF THE DRAWINGS

The above and other aspects, features, and advantages of certain embodiments of the present disclosure will be more apparent from the following detailed description when read in conjunction with the accompanying drawings, in which:

FIG. 1 is a diagram illustrating a communication device, according to an embodiment of the present disclosure; and

FIG. 2 is a flowchart illustrating a method for managing communication records in a communication device, according to an embodiment of the present disclosure.

### DETAILED DESCRIPTION OF EMBODIMENTS OF THE PRESENT INVENTION

Various embodiments of the present disclosure are described in detail below with reference to the accompanying drawings. The same reference numbers are used throughout the drawings to refer to the same or like parts. Additionally, detailed descriptions of well-known functions and structures incorporated herein may be omitted to avoid obscuring the subject matter of the present disclosure.

The terms and words used in the following description and claims are not limited to their dictionary meanings, but are merely used to enable a clear and consistent understanding of the disclosure. Accordingly, it should be apparent to those skilled in the art that the following description of the embodiments of the present disclosure is provided for illustration purpose and not to limit the disclosure, as will defined by the appended claims and their equivalents. Further, those of ordinary skill in the art will recognize that various changes and modifications of the embodiments described herein can be made without departing from the scope and spirit of the present disclosure.

Communication devices have become popular and important for the daily activities of many users. Nowadays, users are increasingly relying upon these communication devices as an integral tool of their social and professional life, and for staying in touch with their family, friends, and acquaintances. The users may use the communication devices to exchange data with other users using one or more communication modes, such as audio calling, text messaging, emails, video calling, and video chatting. Records of such data exchange are usually stored in a storage media of the communication device, and such records include communication details, such as the time of initiation and/or completion of the data exchange, duration of data exchange, and contact details of a user with whom the data exchange took place.

According to an embodiment of the present disclosure, systems and methods for communication records management in communication devices are described herein. The present disclosure facilitates a user with accessing communication records corresponding to all communications made by the user using the communication device in a single window, irrespective of the communication mode used for the communication. The user thus does not need to switch between different windows for using different communication modes, such as audio calling, text messaging, emails, video calling, and video chatting.

In accordance with the embodiments of the present disclosure, a log table having details of one or more communication events is initially analyzed. A communication event may be understood as an exchange of data between a first user, i.e., a user of the communication device with a second user using one of the communication modes supported by the communication device. Based on analysis, a communication record corresponding to each of the communication events may be generated for further processing. In one implementation of the present disclosure, the communication record may include communication details, such as recipient information or a contact ID corresponding to the second user, the communication mode used for the communication, a communication unique ID indicating a specific contact number or email ID used for the communication, communication content.

The communication records may be further analyzed for being classified into one or more communication categories based on one or more classification parameters. The classification parameters can be based on the communication details or can predefined by the user. Examples of the classification parameters include a contact ID of the users, a communication type, the communication mode, and a communication unique ID of the second user used by the first user for interacting with the second user. For instance, the communication records may be initially classified into different user groups based on the contact ID of users interacting with the first user such that all the communication records corresponding to a particular user are grouped together. The communication records in each user group may be further categorized into one or more communication types, such as text, voice, mail, and social interactions. Furthermore, it is also possible that any communication type is implemented through a specific communication mode. For example, a communication type such as a voice call can be carried out through either a normal telephone call or through a VoIP phone (which can be understood as specific communication modes).

The communication records of each communication type may be further categorized based on specific communication modes used for the communication record. For instance, the communication records corresponding to the communication type “text” may be classified into the communication modes text messaging using short message service (SMS) and text messaging using a third party messaging application. Further, for each communication mode the corresponding communication records may be classified based on a communication unique ID, such as a particular email ID or a particular phone number in order to determine preferred communication ID for each communication mode for each user interacting with the first user. Analysis data, having the communication records classified into the communication categories, may be stored for being used for aggregating the communication records for being rendered to a user on a single window of the communication device.

The communication records may be subsequently aggregated in a single presentation view for being rendered to the user based on the above classification of the communication records and one or more contextual parameters corresponding to the communication records. Examples of the contextual parameters include, but are not limited to, frequency of communication using a particular communication mode, duration of the communication, time interval of a day, user location, date time stamp, communication direction (incoming and outgoing), and sensor data corresponding to sensors, such as proximity sensor, accelerometer, gyroscope. The contextual parameters may be obtained from metadata acquired during a communication event and stored in the communication device. In one embodiment, the aggregated communication records may be rendered using the presentation view selected from among one or more presentation views. In this embodiment, the communication events may be rendered along with the content of the communication event in order to facilitate the user in viewing the content of various communication events in a single window. In one implementation, the aggregated communication records may be presented in the form of a timeline view, rendering the communication records in the order of occurrence of their corresponding communication events. In such an implementation, the user may tab on a most recent communication for quickly replying from within the said presentation view and hence avoid switching to the application record to reply to the contact using a preferred communication mode, i.e., the communication mode corresponding to the most recent communication record, thus allowing the user to communicate with the contact without any delay in switching to application hosting the communication mode.

In another implementation of the present disclosure, the aggregated communication records may be presented in the form of a contact list view, rendering last communication event for all contacts saved in the communication device in a predetermined order, which is the most recent communication. In yet another implementation, the communication records for a particular contact may be presented in a contacts view, rendering the communication records for the contact in different groups based on the various communication types used by the user for interacting with the contact. In this implementation, the user may be provided with an instant communication initiation option for communicating with other users. The communication modes for each of the communication type may be provided in the order of their probable usage by the user for interacting with the contact based on weightages assigned to the contextual parameters.

The present disclosure thus facilitates the user in viewing communication records corresponding to all communication modes in a single window. Providing the communication records in a single window allows for a quick and easy method of communication in which the user may communicate without switching between different windows. Providing the instant communication initiation option allows the user to communicate with the contact using any of the available communication modes without having to switch to the particular communication mode. Further, allowing the user to use an instant communication initiation option for communicating without initiating the applications hosting the corresponding communication mode saves computational resources, such as battery and maintaining processing speed of the communication device. Further, classifying the communication records in the various communication categories allows a quick aggregation of the communication records and helps render the aggregated communication records using the various presentation views.

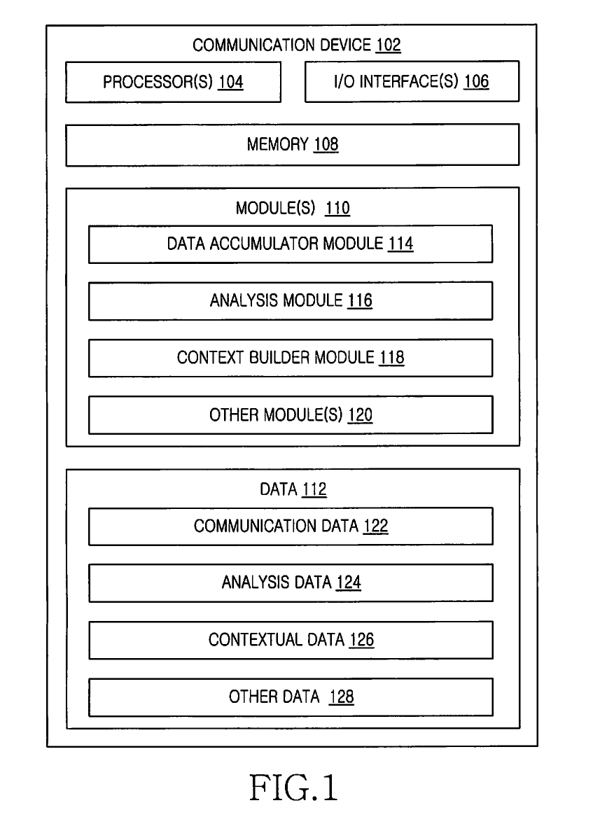

FIG. 1 is a diagram illustrating the components of a communication device 102, in accordance with an embodiment of the present disclosure. The communication device 102 facilitates the user in managing communication records pertaining to data exchanged by the communication device 102 by aggregating the communication records for quick and easy access. The communication device 102 may be implemented as various computing devices, such as a mobile phone, a smart phone, a personal digital assistant, a digital diary, a tablet, a net-book, a laptop computer, and the like.

The communication device 102 includes one or more processor(s) 104, I/O interface(s) 106, and a memory 108 coupled to the processor(s) 104. The processor(s) 104 may be implemented as one or more microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in a memory.

The I/O interface(s) 106 may include a variety of software and hardware interfaces, for example, interfaces for peripheral device(s), such as a keyboard, a mouse, and an external memory. Further, the I/O interfaces 106 may facilitate multiple communications within a wide variety of protocol types including, operating system to application communication, inter process communication, etc.

The memory 108 can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the communication device 102 includes module(s) 110 and data 112. The modules 110 and the data 112 may be coupled to the processor(s) 104. The modules 110, amongst other things, include routines, programs, objects, components, data structures, etc., which perform particular tasks or implement particular abstract data types. The modules 110 may also be implemented as, signal processor(s), state machine(s), logic circuitries, and/or any other device or component that manipulate signals based on operational instructions. In another aspect of the present subject matter, the modules 110 may be computer-readable instructions which, when executed by a processor/processing unit, perform any of the described functionalities. The machine-readable instructions may be stored on an electronic memory device, hard disk, optical disk or other machine-readable storage medium or non-transitory medium. In one implementation, the computer-readable instructions can be also be downloaded to a storage medium via a network connection.

The module(s) 110 includes a data accumulator module 114, an analysis module 116, a context builder module 118, and other module(s) 120. The other module(s) 120 may include programs or coded instructions that supplement applications or functions performed by the communication device 102. The data 112 includes communication data 122, analysis data 124, contextual data 126, and other data 128. The other data 128 amongst other things, may serve as a repository for storing data that is processed, received, or generated as a result of the execution of one or more modules in the module(s) 110. Although the data 112 is shown internal to the communication device 102, it may be understood that the data 112 can reside in an external repository (not shown in FIG. 1), which may be coupled to the communication device 102. The communication device 102 may communicate with the external repository through the I/O interface(s) 106 to obtain information from the data 112.

As previously described, the communication device 102 aggregates the communication records corresponding to one or more communication events occurring using the communication device 102. A communication event indicates occurrence of communication between a user of the communication device 102, e.g., a first user communicates with a second user using a communication mode supported by the communication device 102. Examples of the communication event include a phone call between the first user and the second user, a text message exchanged between the first user and the second user, an email exchanged between the first user and the second user, a social media update, etc. Further, examples of the communication mode include audio calling using a third party application, phone call, text messaging using SMS, text messaging using a third party messaging application, emails, video calling, video chatting, etc.

The log table is maintained in the communication device 102 and may be updated by an application hosting the communication mode used for the communication event. For instance, in the case of the communication event being a conventional phone call, a phone calling application may update the log table by adding details, such as time and date of the phone call, contact number of the user being called, and duration of the phone call. A communication event may also be initiated by one or more third party applications installed on the communication device 102. Examples of such third party applications include third party applications providing video or audio calling, third party messaging applications, and social portals.

In certain cases, the third party applications may not possess the necessary rights for accessing and updating the communication events onto the log table. In absence of such rights, the third party applications may not be able to update the log table. Therefore, in an embodiment of the present disclosure, the data accumulator module 114 updates the log table for communication events taking place using communication modes hosted by third party applications. The data accumulator module 114 in such cases may intercept the communication events taking place using such communication modes and update the log table. The data accumulator module 114 subsequently accesses the log table to analyze the details corresponding to the communication event. In case of the log table being updated by the application, the data accumulator module 114 receives an indication of the occurrence of the communication event.

The data accumulator module 114 analyzes the log table to obtain communication details, such as recipient information, i.e., a contact ID corresponding to the 11 second user, the communication mode used for the communication event, a communication unique ID indicating a specific contact number or email ID used for the communication event, communication content, and additional metadata, such as user location, duration of the communication, communication recording, date time stamp, communication direction (incoming and outgoing), sensor data corresponding to sensors, such as proximity sensor, accelerometer, and gyroscope sensor. The data accumulator module 114 obtains the additional metadata from the other data 128 generated by the other modules 120. For example, in the instance, where the first user called the second user on his office landline number using the conventional phone call for time duration of 20 minutes. In such an instance the recipient information may be a contact ID assigned by the communication device 102 to a contact stored by the second user's name in a contact list of the communication device 102. In the instance where the second user's contacts are not stored in the contact list, the communication device 102 assigns a temporary contact ID for the second user. In this instance, the communication mode may be a phone call; the communication unique ID may be the specific number used for the call, i.e., the office landline number of the second user, out of one or more contact numbers stored for the second user; the communication content may be the time duration of the call or a link to a recording of the call.

In another example, let's assume that the first user sent an email to the second user on his office email ID using the first user's official email ID accessed through a third party email application. In such an instance, the recipient information may be the contact ID assigned by the communication device 102 to the contact stored by the second user's name in the contact list of the communication device 102. In the instance where the second user's contacts are not stored in the contact list, the communication device 102 assigns a temporary contact ID for the second user. Further, the communication mode in this instance may be the third party email application; the communication unique ID may be the second user's official email ID; the communication content may be the content, i.e., subject, body, and attachment of the email.

The data accumulator module 114 subsequently generates a communication record corresponding to each of the communication event. As previously described, the communication record may include the communication details. The data accumulator module 114 further saves the communication record for the current communication event in the communication data 122 along with the communication records corresponding to the other 12 communication events for further processing. The communication record may be generated in a predetermined format that may be read by the analysis module 116 for further processing.

The analysis module 116 further analyzes the communication records for classifying them into one or more communication categories for the aggregation process. The communication records may be classified based on one or more classification parameters, such as the contact ID of the second user, a communication type, the communication mode, and the communication unique ID of the second user used by the first user for interacting with the second user. The communication type may be understood as the type of communication event, for example, text, voice, mail, social interactions, etc., that may take place between the first user and the second user.

Initially, the analysis module 116 contextually classifies the communication records into different user groups based on the contact ID of users interacting with the first user. The communication records may be contextually classified such that all the communication records corresponding to a particular user are grouped together, thus allowing the first user to view all the communication records pertaining to the particular user, alternately referred to as a contact, in a single window. To this end, the analysis module 116 obtains the communication records saved in the communication data 122 and scans the contact ID of all the communication records. The records having the same communication ID may then be grouped together to form different user groups, irrespective of the corresponding communication mode. For example, the communication records corresponding to the second user may be grouped together to form a user group, similarly the communication records corresponding to a third user may be grouped together to form another user group.

The analysis module 116 further classifies the communication records in each user group into one or more communication type categories based on the communication types of the communication record. The analysis module 116 analyzes all the communications records in a user group to ascertain a communication type code provided in the communication record. The communication type code may be indicated in the log table by the application while updating the log table and copied into the communication record by the data accumulator module 114. The communication type code may be, for example, numeric digit 1 for voice, 2 for text, 3 for email, 4 for social interactions, and so on. The analysis module 116 determines the communication type for each of the communication records and categorizes the communication record in each user group into the various communication type categories, such as voice, text, email, and social interactions.

Further, the analysis module 116 categorizes the communication records of each communication type, in each user group, into specific communication modes based on the communication modes used for the communication. For example, in the communication type “text”, the analysis module 116 classifies the communication records into SMS, text messaging using a third party messaging application “abc”, text messaging using another third party messaging application “xyz”. Similarly, for the communication type “voice”, the analysis module 116 classifies the communication records into phone call, audio call using a third party application, video call using another third party application, and video call using a proprietary video calling application of the communication device 102. The analysis module 116 analyzes the communications records in a communication type category to ascertain a communication mode code provided in the communication record. The communication mode code, in one implementation, may be indicated in the log table by the application while updating the log table and copied into the communication record by the data accumulator module 114. The communication mode code in case of communication type “voice” may be, for example, numeric digit 1 for phone call, 2 for audio call using a particular third party application, 3 for video call using another third party application, 4 for video call using the proprietary video calling application, and so on. Classifying the communication records based on the communication mode facilitates in determining a preferred communication mode for each user, i.e., the communication mode preferred by the first user for interacting with a particular user.

Further, for each communication mode, the analysis module 116 classifies the corresponding communication records based on the unique communication ID associated with the communication record in order to determine preferred communication ID for each communication mode for each user interacting with the first user. The preferred communication ID may be one of the various communication unique IDs of the second user, used by the first user for interacting with the second user. The analysis module 116 further saves the above classification data in the analysis data 124 for being used for aggregating the communication records for being rendered to a user on a single window of the communication device 102.

The context builder module 118 subsequently analyzes the analysis data 124 for aggregating the communication records for being presented in a single presentation view. The context builder module 118 aggregates the communication records based on the above classification of the communication records and weightage assigned to one or more contextual parameters corresponding to the communication records. The contextual parameters indicate relevance of the communication record and the communication mode corresponding to the communication record and may thus be used for aggregating the communication records as well as for determining communication modes that may be used for instant communication initiation. Examples of the contextual parameters include, but are not limited to, frequency of usage of a particular communication mode, frequency of usage of a particular communication unique ID, duration of the communication, time interval of a day, location of the user, context of the conversation, sensor data from various sensors provided in the communication device 102, such as proximity sensor, accelerometer, gyroscope, and user profile of the communication device 102.

Frequency of usage of a particular communication mode may be understood as the number of times the communication mode has been used for interacting with a particular user. The frequency of usage of a particular communication mode may be determined based on the classification of the communication records into the different modes. The context builder module 118 analyzes the analysis data 124 to determine the number of times a particular communication mode, e.g., a phone number or a third party audio calling application, has been used by the first user for interacting with a particular user. Based on the determination, the context builder module 118 ranks the communication modes in each communication type for each user group and assigns a weightage to each communication mode based on the ranking. Duration of the communication may be understood as total duration for which a particular communication mode has been used for interacting with a particular user. Time interval of a day may be defined by dividing a day into different segments, e.g., morning, day, evening, and night. The context builder module 118 analyzes the analysis data 124 to determine the communication mode that the first user prefers to use to interact with a particular user in a particular time interval and assigns weightage to each time interval based on the same. For example, if the first user uses a second user's mobile number to interact with him in the evening and prefers to call using a third party audio application in the morning, the context builder module 118 assigns higher weightage to the mobile number when the first user is using the communication device 102 in the evening.

User location may be used by the contextual builder module 118 for assigning weightage to different communication modes based on the user location while using the communication device 102. For example, if the first user is in proximity of a WiFi router, the context builder module 118 assigns higher weightage to a third party messaging application using internet connection as compared to SMS services. User profile of the communication device 102 may be understood as sound and other settings of the communication device 102 set by the user. User profiles may be, for example, silent profile, loud profile, and meeting profile. The context builder module 118 assigns weightage to different communication modes based on usage of the communication modes in the various user profiles, thus the communication mode that is used most frequently for interacting when the communication device 102 is in a particular user profile may be given the highest weightage.

Context of communication may be understood as topic or subject of communication and may be used when the communication device 102 is able to read the keywords and suggest the user contacts with whom the first user has had a conversation using the same keywords. Further, there could be content and contact clusters built around indexed words in the conversations. The sensor data from various sensors provided in the communication device 102 may be used to determine whether the first user is in motion, for example, when the first user is driving or walking, then the voice call mode may have more weightage than the texting mode.

Upon being aggregated and assigned the weightages, the context builder module 118 renders the communication records on a display screen (not shown in the FIGS.) of the communication device 102 using a presentation view selected from among one or more predefined presentation views. Further, the communication events may be rendered along with the content of the communication event in order to facilitate the user to view the content of various communication events in a single window.

The context builder module 118 renders the aggregated communication records in the form of a timeline view. In such a view, the communication records may be arranged in the order of occurrence of their corresponding communication events such that communication record corresponding to a most recent communication event is rendered at the top. The timeline view may thus present all the communication records for all the users in a single window. The context builder module 118 further provides the communication records such that when the first user tabs on a most recent communication record corresponding to a particular user to reply to the user, a preferred communication mode, i.e., the communication mode corresponding to the most recent communication record, is opened up thus allowing the user to communicate with the contact without any delay in switching to application hosting the communication mode. The most preferred communication record may be determined by the context builder mode based on the time of the communication event indicated in the communication record.

The context builder module 118 presents the aggregated communication records in the form of a contact list view. In such a view, the most recent communication event for all contacts saved in the communication device 102 are displayed in a predetermined order. For instance, the most recent communication event for all contacts saved in the communication device 102 may be rendered in a chronological order of the contacts name. Further, in the instance where the first user wants to view all the communication records corresponding to a particular user, the first user may select the user's image portrayed along with the most recent communication event. On selection of the image by the user, the context builder module 118 provides the communication records corresponding to the particular user selected by the first user.

The context builder module 118 presents the communication records for a particular contact in a contacts view. In such a view, the communication records for a particular contact are displayed together in different groups based on the various communication types used by the user for interacting with the contact. Providing the aggregated communication records in the contacts view allows the first user to view all the communications he had with the particular contact in a quick and easy method.

Further, the context builder module 118 provides an instant communication initiation option to the first user for communicating with other users instantly through the presentation view. The context builder module 118 arranges the communication modes for each of the communication type in the order of their probable usage by the user for interacting with the contact. The order of the probable usage may be determined based on the weightage assigned to the contextual parameters and may differ for each contact. The context builder module 118 determines weightage for the contextual parameters for each communication record and rank the corresponding communication modes based on a total weight.

The total weight for each communication mode for determining the instant communication initiation option is based on weight which can be calculated by following formula with configurable weights. Total Weight=(Number of calls from a specific communication unique ID)×W1+(duration of communication)×W2+(Event in certain time interval or pattern as per previous usage data with tolerance)×W3+(Communication direction incoming/outgoing pattern)×W4+(Current Location being in certain location range or pattern)×W5+(Current user profile state)×W6+(Communication information, such as communication type, communication mode)×W7+(sensor data)×W8, where weights Wn can be calibrated by the context builder module 118 to modify the relevance of parameters.

For example, when the first user views the communication records corresponding to the communication type “voice” for a particular contact in the contacts view, the context builder module 118 arranges the different communication modes associated with voice communication type in the order of their probable usage based on the different contextual parameters. For example, the context builder module 118 determines the weightage assigned to the different communication modes based on the contextual parameters, such as the time interval, the user profile, and the frequency of usage and arrange the communication modes accordingly. It will be understood that order of the communication modes may differ for each time interval or each user profile based on the weightages assigned.

In order to use the instant communication initiation option, the first user selects any of the available communication modes to use the same without actually switching to the particular communication mode. For example, in case the user wants to use the instant communication initiation option in the communication type “voice”, the user may be provided with a list of the communication modes in the order of their probable usage and the user may simply select the communication mode of his preference to interact with the second user without actually switching to the particular communication mode. In another example, if the user wants to use the instant communication initiation option in the communication type “text”, the user may be provided with a compose screen to write a text and send the text to the other user using any of the available texting related communication mode without actually switching to the particular communication mode.

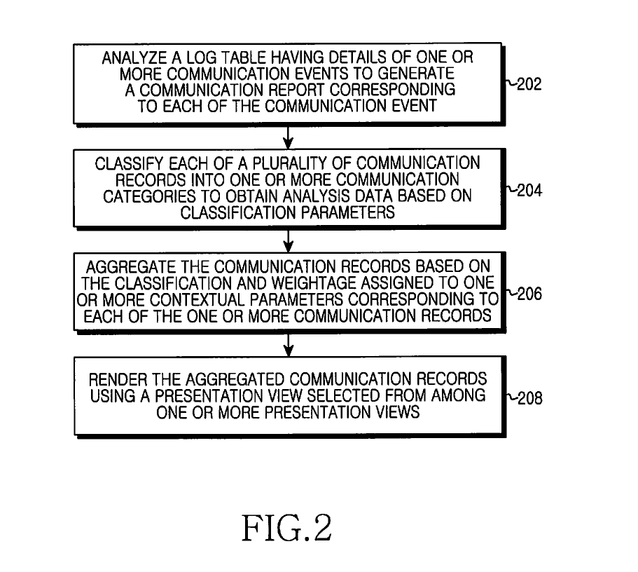

FIG. 2 is a flowchart illustrating a method for managing communication records in a communication device, according to an embodiment of the present subject matter. The order in which the method is described is not intended to be construed as a limitation, and any number of the described method blocks can be combined in any order to implement the method, or any alternative methods. Additionally, individual blocks may be deleted from the method without departing from the spirit and scope of the subject matter described herein. Furthermore, the method can be implemented in any suitable hardware, software, firmware, or combination thereof.

The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method can be performed by programmed computers and communication devices. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform the steps of the method.

At step 202, a log table having details of one or more communication events is analyzed. The communication event indicates an occurrence of communication between a first user and a second user using a communication mode from among a plurality of communication modes. A communication device, such as the communication device 102 analyzes the log table to generate a communication record corresponding to each of the communication events. The communication record may be further saved in communication data of the communication device along with other communication records.

At step 204, each of a plurality of communication records is classified into one or more communication categories. The communication device 102 classifies each communication record into one or more communication categories based on one or more classification parameters to obtain analysis data. The classification parameters may include, for example, a contact ID of the second user, a communication type, the communication mode, and a communication unique ID of the second user used by the first user for interacting with the second user. The communication records may be initially classified into different user groups based on the contact ID of users interacting with the first user such that all the communication records corresponding to a particular user are grouped together. The communication records in each user group may be further categorized into one or more communication types, such as text, voice, mail, and social interactions. The communication records of each communication type may be further categorized into specific communication modes based on the communication modes used for the communication. Further, for each communication mode the corresponding communication records may be classified based on a communication unique ID, such as a particular email ID or a particular phone number.

At step 206, the communication records are aggregated based on the classification and weightage assigned to one or more contextual parameters corresponding to each of the one or more communication records. Examples of the contextual parameters include, but are not limited to, frequency of usage of a particular communication mode, frequency of usage of a particular communication unique ID, duration of the communication, time interval of a day, user location, usage behavior, context of the conversation, sensor data from various sensors provided in the communication device 102, and user profile of the communication device 102.

At step 208, the aggregated communication records are aggregated using a presentation view selected from among one or more presentation views. For example, the one or more presentation views may include a timeline view, a contact list view, and a contacts view. In the timeline view, the communication records may be rendered in the order of occurrence of their corresponding communication events. In the contact list view, last communication event for all contacts saved in the communication device may be rendered in a predetermined order. In the contacts view, the communication records for a particular contact may be rendered in different groups based on the various communication types used by the user for interacting with the contact. In the contacts view, the user may be provided with an instant communication initiation option for communicating with other users. With this purpose in mind, the communication modes for each of the communication type may be provided in the order of their probable usage by the user for interacting with the contact. The order of the probable usage may be determined based on, for example, the weightage assigned to the contextual parameters and may differ for each contact.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. A method in an electronic device, the method comprising:
obtaining a communication record corresponding to each of one or more communication events, wherein the communication event indicates an occurrence of communication between a first user and a second user using a communication mode from among a plurality of communication modes;
classifying each of a plurality of communication records corresponding to the one or more communication events, into one or more communication categories based on one or more classification parameters; and
aggregating the plurality of communication records based on the classifying and weightage assigned to one or more contextual parameters corresponding to each of the plurality of communication records, wherein the contextual parameters indicate relevance of the communication record and the corresponding communication mode corresponding to the communication record.

2. The method as claimed in claim 1, further comprising rendering the aggregated communication records using a single presentation view, wherein the presentation view is selected from among one or more presentation views.

3. The method as claimed in claim 2, wherein the one or more presentation views include:
a timeline view rendering the communication records in an order of occurrence of their corresponding communication events, and wherein a communication record corresponding to a most recent communication event is rendered at top;
a contact list view rendering the most recent communication event for all contacts saved in the electronic device in a predetermined order; and a contacts view rendering the communication records for a particular user in the single presentation view, wherein the communication records are categorized into the communication categories based on communication types used by the user for interacting with the particular user, and wherein the communication types is one of text, voice, mail, and social interactions.

4. The method as claimed in claim 1, wherein aggregating the plurality of communication records further comprises providing an instant communication initiation option to the first user for initiating communication with the second user directly through a single presentation view.

5. The method as claimed in claim 4, wherein providing the instant communication initiation option further comprises:
determining ranking for the communication modes associated with each of the communication records corresponding to a particular user based on the weightages assigned to the one or more contextual parameters; and
arranging the communication modes for each of the communication type in an order of their probable usage by the first user for interacting with the particular user based on the ranking.

6. The method as claimed in claim 1, wherein aggregating the plurality of communication records further comprises:
ascertaining a most recent communication event from one or more communication events corresponding to the second user based on a time of the communication event indicated in the corresponding communication record; and
determining a communication mode used for most recent communication event as a preferred communication mode used by the first user for communicating with the second user.

7. The method as claimed in claim 1, wherein classifying each of a plurality of communication records corresponding to the one or more communication events further comprises categorizing the plurality of communication records into different user groups based on a contact ID of users interacting with the first user, and wherein the communication records corresponding to a particular user are grouped together to form a single user group.

8. The method as claimed in claim 7, wherein classifying each of a plurality of communication records corresponding to the one or more communication events further comprises categorizing the communication records in each user group into one or more communication types, wherein the communication types is one of text, voice, mail, and social interactions.

9. The method as claimed in claim 8, wherein classifying each of a plurality of communication records corresponding to the one or more communication events further comprises categorizing the communication records in each communication type, for each user group, into one or more specific communication modes based on the communication modes corresponding to the communication record, wherein the communication modes include audio calling using a third party application, phone calling, text messaging using short message service (SMS), text messaging using a third party messaging application, emails, video calling, and video chatting.

10. The method as claimed in claim 1, further comprising
analyzing a log table having details of the one or more communication events; and
generating a communication record corresponding to each of the communication event based on the analyzing.

11. The method as claimed in claim 1, wherein the classification parameters include a contact ID of the second user, a communication type, the communication mode, and a communication unique ID.

12. The method as claimed in claim 1, wherein the contextual parameters include frequency of usage of a particular communication mode, duration of the communication, time interval of a day, location of the first user, usage behavior of the first user, sensor data corresponding to one or more sensors provided in the electronic device, and user profile of the electronic device.

13. An electronic device comprising:
a processor;
a data accumulator module coupled to the processor to obtain a communication report corresponding to each of one or more communication events, wherein the communication event indicates an occurrence of communication between a first user and a second user using a communication mode from among a plurality of communication modes;
an analysis module coupled to the processor to classify each of a plurality of communication records corresponding to one or more communication events, into one or more communication categories based on one or more classification parameters; and
a context builder module coupled to the processor) configured to aggregate the plurality of communication records based on the classifying and weightage assigned to one or more contextual parameters corresponding to each of the plurality of communication records, wherein the contextual parameters indicate relevance of the communication record and the communication mode corresponding to the communication record.

14. The electronic device as claimed in claim 13, wherein the context builder module is further configured to render the aggregated communication records using a single presentation view, wherein the presentation view is selected from among one or more presentation views.

15. The electronic device as claimed in claim 14, wherein the one or more presentation views include:
a timeline view rendering the communication records in an order of occurrence of their corresponding communication events, and wherein the communication record corresponding to a most recent communication event is rendered at top;
a contact list view rendering the most recent communication event for all contacts saved in the electronic device in a predetermined order; and
a contacts view rendering the communication records for a particular user in a single presentation view, wherein the communication records are categorized into the communication categories based on the communication types used by the user for interacting with the particular user, and wherein the communication types is one of text, voice, mail, and social interactions.

16. The electronic device as claimed in claim 13, wherein the context builder module is further configured to provide an instant communication initiation option to the first user for initiating communication with the second user directly through a single presentation view.

17. The electronic device as claimed in claim 16, wherein the context builder module is further configured to:
determine ranking for the communication modes associated with each of the communication records corresponding to the particular user based on the weightages assigned to the one or more contextual parameters; and
arrange the communication modes for each of the communication type in an order of their probable usage by the first user for interacting with the particular user based on the ranking.

18. The electronic device as claimed in claim 13, wherein the context builder module is further configured to:
ascertain a most recent communication event from one or more communication events corresponding to the second user based on the time of the communication event indicated in the corresponding communication record; and
determine a communication mode used for most recent communication event as a preferred communication mode used by the first user for communicating with the second user.

19. The electronic device as claimed in claim 13, wherein the analysis module is further configured to classify the plurality of communication records into different user groups based on contact ID of users interacting with the first user, and wherein the communication records corresponding to a particular user are grouped together to form a single user group.

20. An electronic device comprising:
a processor;
a data accumulator module coupled to the processor to obtain a communication report corresponding to each of one or more communication events, wherein the communication event indicates an occurrence of communication between a first user and a second user using a communication mode from among a plurality of communication modes;
an analysis module coupled to the processor to classify each of a plurality of communication records corresponding to one or more communication events, into one or more communication categories based on one or more classification parameters; and
a context builder module coupled to the processor configured to:
determine ranking for each of the plurality of communication modes associated with each of the communication records corresponding to the second user based on weightages assigned to one or more contextual parameters, wherein the contextual parameters indicate relevance of the communication record and the communication mode corresponding to the communication record;
aggregate the plurality of communication records in a single presentation view based on the classifying, wherein the communication modes for each of a communication type are arranged in an order of their probable usage by the first user for interacting with the second user based on the ranking for providing an instant communication initiation option to the first user for initiating communication with the second user directly through the presentation view.
